(19) United States
(12) Patent Application Publication
(10) Pub. No.: US 2006/0129568 A1
(43) Pub. Date: Jun. 15, 2006

(54) Dimensional Data in Research Enterprise Systems

(76) Inventor: Samuel Beckey, Rancho Santa Fe, CA (US)

Correspondence Address: SAMUEL SCOTT BECKEY, P.O. BOX 675466, RANCHO SANTA FE, CA, 92067, US

(21) Appl. No.: 10/905,049

(22) Filed: Dec. 13, 2004

(51) Int. Cl. G06F 7/00

(52) U.S. Cl. 707/100

(57) ABSTRACT

A system and method for organizing information pertaining to creative and ad-hoc processes, such as are used in research. Information is stored in a database and indexed simultaneously in three dimensions, representing protocol, objects, and activity. Indexes within each dimension reflect best industry practice and can include object, clustered, indexed, and hierarchical views, while the invention is distinguished by maintaining three indexes simultaneously.

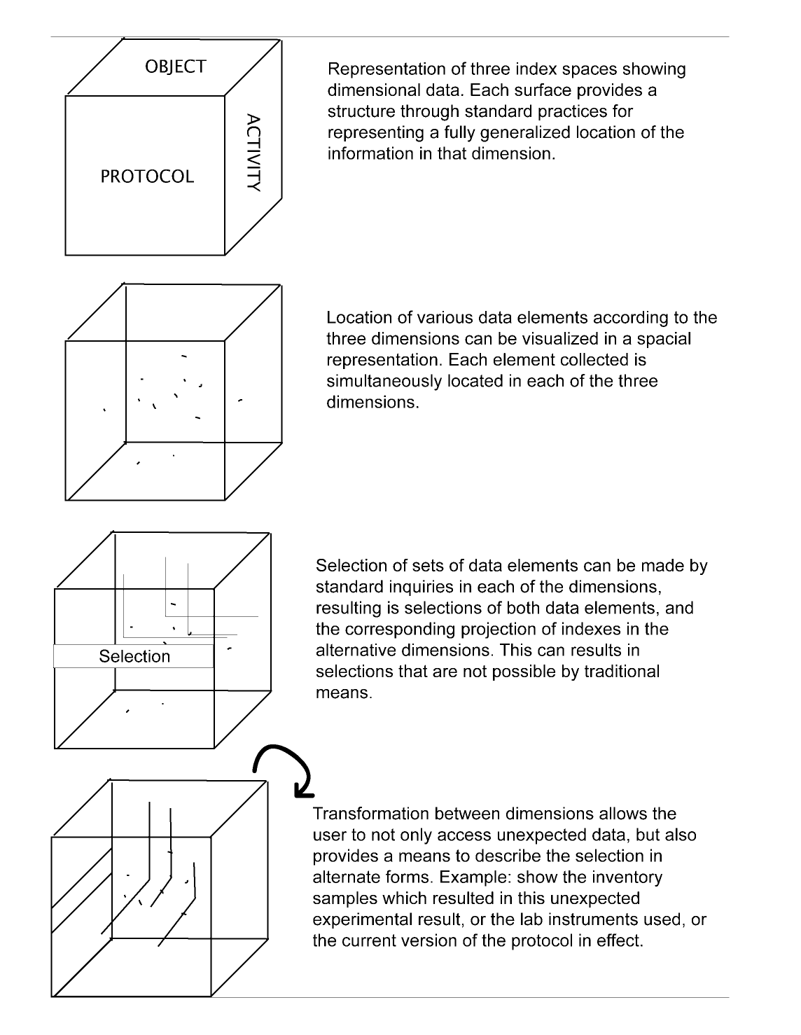

### DIMENSIONAL REPRESENTATION

The subject invention introduces a multi-dimensional data representation scheme, likely implemented on a computer database, or a network of computer databases, where all information in organized in dimensions related to the work performed. In particular, the dimensions are protocol, objects, and activity and all acquired data is related in context to the dimensions. The organization is suitable for many applications, in this instance it is applied to management of research processes. Research information management is a field which is critical to productivity and innovation in science, engineering, and product development.

The subject invention allows organization of information in a research environment in order to coordinate researchers, capture all relevant information, and maximize the value of information collected. Using computer technology and in particular advanced data structures, the subject invention places information in context based on a number of organizing principles in three dimensions. The dimensions acknowledge the organization of work into protocols, inventories, and activity. Protocols are the procedures used to perform work, often expressed as work flows, flowcharts, recipes, and work instructions. Inventories are all the objects that are used in the protocols, which are often organized in sets, collections, or locations. Activity is not just the results, but also the record of each operation (protocol) on each (object) item in the inventory.

By maintaining the multi-dimensional representation of information, and collecting data with reference to the context in each dimension, the information gathered has typically greater value than more conventional techniques.

### PROTOCOL

Protocol provides information about processes, whether or not they have been executed. Information is arranged according to any of a number of traditional methods, including a strict or modified hierarchy, a nodal tree, or via relational and searchable methods. Protocols consist of steps, which can be nested (in sub protocols, for instance).

### OBJECTS & INVENTORY

Objects are generalized inventory items. Inventory can represent any physical or virtual object, such as molecules, compound libraries, containers (vials, tubes, plates, arrays, chips). Object oriented data storage is desirable, as inventory often inherits properties of other inventory.

### ACTIVITY

Activity is not limited to measurements and readouts, but includes all instances where a protocol step occurs in reference to an object. Typically stored as time series data, activity gains greater importance using contextual data collection.

### COMPARISON WITH EXISTING METHODS

This invention is the basis for an enterprise research system, which is based on the convergence of research software (or informatics) with enterprise business systems (or Enterprise Resource Planning: ERP Systems).

### INFORMATICS

The field of informatics often provides algorithm based computing which performs novel operations on data representation of various research elements (sequences, structures, laboratory results). Informatics software generally addresses one or perhaps two of the three dimensions discussed. Software such as LIMS (Laboratory Instrument Management Systems) offer collection and management of activities, and may have a protocol component. Certain resource tracking solutions (lab inventory systems) focus on the tracking the use of particular consumables, and may provide a identity for inventory objects, but a complete solution relies on the availability of information about potentially all objects used in the research process. Management of an entire research process requires that the solution include all the dimensions, and that a high degree of integration between dimensions is maintained.

### ENTERPRISE SYSTEMS

The ERP solutions available are rarely applicable to the world of the research scientist. ERP systems have capabilities to represent the complexity of all three dimensions, yet are not designed for situations where the protocols may be defined ad-hoc, and where the output of the process in information itself. The activity dimension is present in some shop floor management systems, and certain quality data collection applications.

### CONTEXTUAL DATA

Contextual data collection is the process by which information in each of the three dimensions is recorded for each piece of data generated by the research process. Many systems and lab instruments generate information, but it is often discarded or stored in a way that fails to identify it in the appropriate context. Lab data collection systems to be optimal, should record information about the protocol in effect, the objects used to generate the result, and the result itself in order to maintain full context of the data.

This invention provides the information architecture for a research enterprise system which can represent all the complexity of a scientific research process, for instance the drug discovery process in the pharmaceutical industry. It allows enough information to be collected so that experiments are repeatable, that all the conditions in each dimension can be recorded, and so that the information created during the experiment can be maintained, contextualized, and re-used by the enterprise. The invention and the associated research enterprise system also have application to the effective management of research programs.

### REFERENCES AND DISCUSSION

Reference: U.S. Pat. No. 6,658,429 Dorsett Dec. 2, 2003

Dorsett describes a laboratory database for a particular field, ie: combinatorial materials research as conducted at Symyx. Dorsett begins by receiving data from a chemical experiment on a library of materials, as is often done in activity oriented databases. He then defines a specific representation of the experiment in a taxonomy of experimental types, assigning each experiment to particular classes.

Our dimensional approach to research management achieves the same objectives in a more generalized format. The dimensional database builds general representations of each dimension, such that the protocol dimensions provides a structure to define any experiment; the inventory dimension offers the ability to not only record everything about a combinatorial library, but also every other element used in the experiment including the equipment, reagents, substrates, consumables, labware, materials, even the people performing the experiment; the activity dimension recording not only the results of the experiment, but also every precursor step leading to the results.

Reference: U.S. Pat. No. 6,594,654 Salam, et al Jul. 15, 2003

Salam describes a method of conducting research through web sites in a computer network which is not the same a using a computer to conduct research. Selection of data from a variety of search engines and information sources is an important part of the research process.

Within a research enterprise, expert users exist who are searching many databases on a regular basis. The dimensional data approach is concerned with providing a framework to allow the enterprise to record the technique, inquries, and results of that research. It is possible that the user will be able to access an advanced searching capability as described in Salam. Dimensional data offers the ability to place that action in the context of all the other functions being performed according to its place in a Protocol, its results stored as Activity, and its relation to items in use in the research process (Inventory). A scientist who performs a general lookup on the internet, as a regular part of his research process, seeking for instance a known agonist in a disease process, is simultaneously working in the three dimensions described in dimensional data. He might incidentally use any of a number of advanced inquiry tools, such as the one defined in Salam.

Reference: U.S. Pat. No. 6,472,218 Stylli, et al Oct. 29, 2002

Within the “Data Processing and Integration Module” discussion of this patent on high throughput screening, the authors define a database that uses data entities to control the flow of an automated assay. This is a non-generalized version of the protocol management that we propose. The integrated instruments in high throughput screening can be thought of to also include human workstations, but this provides a more regimented environment than is acceptable to most scientists and laboratories. The screening system defined also includes a complex representation of the library which is very specific to the management of samples in various microplate formats.

What is claimed is:

1. Organization of information in scientific research systems into the dimensions of Protocol, Activity, and Inventory:
a. A data structure representing a plurality of protocols, flowcharts, or work flows used to conduct research. Said protocols being work instructions for groups, individuals, or programmable or configurable research devices. Protocols are made up of operations, which are representable as steps within protocols;
b. A data structure representing objects found in the research inventory, including all items which are necessary to conduct research. These will include but are not limited to facilities, devices, chemical and biological inventories, reagents, test objects, labware, media, and computing devices;
c. A data structure representing any Activity which can be conducted using the protocols and objects. The activity data structure can contain a record of any and all operations performed as part of a protocol on any object contained in the inventory.

2. Creating hierarchical or other information organizations within each dimension according to conventional practice, such methods can include trees, nodal organizations, tables, time sequences, or other schemes.

3. Simultaneous management of the indexes in all three dimensions, such that each new piece of information can be placed according to its position in all dimensions.

4. Representation of multiple data dimensions in a cube and the visual display of the cube as part of a user interface, referencing the three dimensions given.

5. The implementation of the described invention in a modern relational database, distinguished by the provision of three indexing mechanisms in the data schema.

6. The ability to transform data between views in different dimensions, for instance by “spinning the cube” from a selection of interesting activity data, the user could view the protocol(s) in effect which produced the data, or transform again to object view and observe the items (containers, reagents, substrates, samples, and parents of samples) which were used in the actual experiment.
